(19) United States
(12) Patent Application Publication
(10) Pub. No.: US 2022/0295166 A1
(43) Pub. Date: Sep. 15, 2022

(54) EARPHONE CASE AND EARPHONE KIT

(71) Applicant: LUXSHARE PRECISION INDUSTRY CO., LTD., Shenzhen (CN)

(72) Inventors: Yun FENG, Shenzhen (CN); Guoqin HUANG, Shenzhen (CN); Yong HUANG, Shenzhen (CN)

(73) Assignee: LUXSHARE PRECISION INDUSTRY CO., LTD., Shenzhen (CN)

(21) Appl. No.: 17/563,965

(22) Filed: Dec. 28, 2021

(30) Foreign Application Priority Data
Mar. 12, 2021 (CN) 202120524806.6

(51) Int. Cl. H04R 1/10

(52) U.S. Cl. CPC H04R 1/105; H04R 1/1016; H04R 1/1091; H04R 2201/10; H04R 2420/07

(57) ABSTRACT

Provided are an earphone case and an earphone kit. The earphone case includes a case body and a case cover. The case body is provided with a first accommodation recess for accommodating a left earphone and a second accommodation recess for accommodating a right earphone. The case cover is used for covering the case body. The outer surface of at least one of the case body or the case cove is coated with a first coating and a second coating of different colors side by side, where the first coating faces the first accommodation recess, and the second coating faces the second accommodation recess.

### CROSS-REFERENCE TO RELATED APPLICATION

This application claims priority to Chinese Patent Application No. 202120524806.6 filed with the CNIPA on Mar. 12, 2021, the disclosure of which is incorporated herein by reference in its entirety.

### TECHNICAL FIELD

The present disclosure relates to the technical field of earphones and, in particular, to an earphone case and an earphone kit.

### BACKGROUND

Wireless earphones are compact in size and easy to carry and thus are widely welcomed by consumers. To accommodate the wireless earphones, earphone cases are developing towards integration, portability, and aesthetics. Some of the earphone cases may also have the function of wireless charging.

An existing earphone case of binaural earphones is mainly used for carrying left and right wireless earphones. However, such an earphone case is relatively simple in structure, only provided with a first accommodation recess for accommodating a left earphone and a second accommodation recess for accommodating a right earphone. No additional structure is disposed in the earphone case. The problem lies in that when placing earphones into the earphone case, consumers have difficulty distinguishing between the first accommodation recess and the second accommodation recess. The inconvenience in placing the left earphone and the right earphone distinctively has a negative impact on the user experience. Moreover, the earphone case is not aesthetic enough.

### SUMMARY

The present disclosure provides an earphone case. The earphone case has an aesthetic appearance and can help consumers distinguish between a first accommodation recess and a second accommodation recess quickly, making it easy for consumers to place a left earphone and a right earphone into the first accommodation recess and the second accommodation recess respectively and thus improving the user experience.

To achieve this object, the present disclosure adopts the technical solutions below.

The present disclosure provides an earphone case.

The earphone case includes a case body and a case cover. The case body is provided with a first accommodation recess for accommodating a left earphone and a second accommodation recess for accommodating a right earphone. The case cover is used for covering the case body.

The outer surface of at least one of the case body or the case cover is coated with a first coating and a second coating of different colors side by side, where the first coating faces the first accommodation recess, and the second coating faces the second accommodation recess.

In an embodiment, the left half of the outer surface of the case body and the left half of the outer surface of the case cover are coated with the first coating. The right half of the outer surface of the case body and the right half of the outer surface of the case cover are coated with the second coating.

In an embodiment, the shell of the case cover and the shell of the case body are each semi-oval. When the case cover covers the case body, the case cover and the case body form an oval structure.

In an embodiment, the case cover is pivotably connected to the case body by using a pivot shaft.

In an embodiment, an opening and closing notch is disposed in the outer wall of the case body. The opening and closing notch penetrates through a side wall of the case body facing the case cover.

In an embodiment, a locking magnetic block is disposed at the opening and closing notch of the case body. A metal piece attractable by the locking magnetic block is disposed on the case cover.

In an embodiment, the case body is further provided with a first mark and a second mark for distinguishing between the first accommodation recess and the second accommodation recess. The first mark is disposed on a side of the first accommodation recess. The second mark is disposed on a side of the second accommodation recess.

In an embodiment, a first stop recess and a second stop recess are disposed in the inner wall of the case cover. When the case cover covers the case body, the inner wall of the first stop recess is abuttable against and stopped by the outer wall of the left earphone, and the inner wall of the second stop recess is abuttable against and stopped by the outer wall of the right earphone.

The present disclosure further provides an earphone kit. The earphone kit has an aesthetic appearance and can help consumers distinguish between a first accommodation recess and a second accommodation recess quickly, making it easy for consumers to place a left earphone and a right earphone into the first accommodation recess and the second accommodation recess respectively and thus improving the user experience

To achieve this object, the present disclosure adopts the technical solutions below.

The present disclosure provides an earphone kit. The earphone kit includes the preceding earphone case, a left earphone, and a right earphone.

The outer surface of the left earphone is coated with the first coating.

The outer surface of the right earphone is coated with the second coating.

In an embodiment, both the first accommodation recess and the second accommodation recess are provided with a first magnetic piece. Both the left earphone and the right earphone are provided with a second magnetic piece. The second magnetic piece on the left earphone is attractable to the first magnetic piece in the first accommodation recess. The second magnetic piece on the right earphone is attractable to the first magnetic piece in the second accommodation recess.

### BRIEF DESCRIPTION OF DRAWINGS

FIG. 1 is a schematic view illustrating the structure of an earphone case according to the present disclosure.

FIG. 2 is a schematic view illustrating the structure of the earphone case when the earphone case is disassembled according to the present disclosure.

FIG. 3 is a schematic view of a case body that accommodates a left earphone and a right earphone according to the present disclosure.

FIG. 4 is a schematic view of a left earphone and a right earphone of an earphone kit according to the present disclosure.

### REFERENCE LIST

1 case body
11 first accommodation recess
12 second accommodation recess
13 opening and closing notch
2 case cover
21 first stop recess
22 second stop recess
3 coating boundary
5 left earphone
6 right earphone
7 first magnetic piece
8 second magnetic piece

### DETAILED DESCRIPTION

To make solved technical problems, adopted technical solutions and achieved technical effects of the present disclosure more apparent, the technical solutions of the present disclosure are further described hereinafter in conjunction with drawings and embodiments.

In the description of the present disclosure, terms “joined”, “connected”, and “fixed” are to be understood in a broad sense unless otherwise expressly specified and limited. For example, the term “connected” may refer to “securely connected” or “detachably connected”, may refer to “mechanically connected” or “electrically connected” or may refer to “connected directly”, “connected indirectly through an intermediary”, “connected inside two components” or “interacted between two components”. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact, or be in contact via another feature between the two features instead of being in direct contact. Moreover, when the first feature is described as “on”, “above” or “over” the second feature, the first feature is right on or obliquely on the second feature, or the first feature is simply at a horizontally higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of this embodiment, orientations or position relations indicated by terms such as “center”, “upper”, “lower”, “left”, and “right” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. Moreover, terms such as “first” and “second” are used only for the purpose of description and are not to be construed as indicating or implying relative importance.

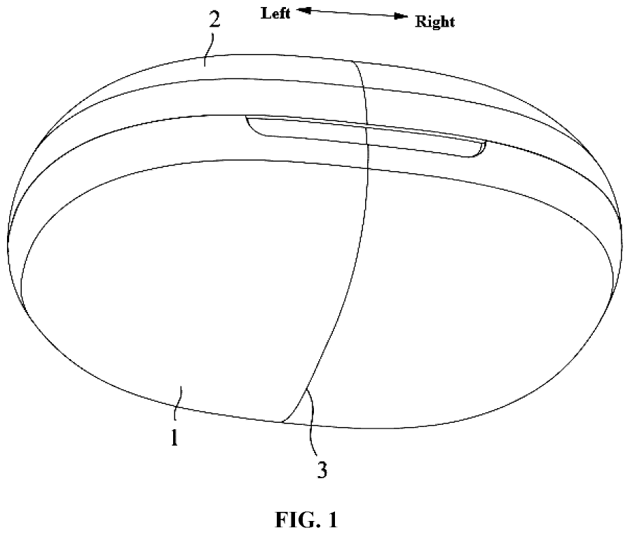

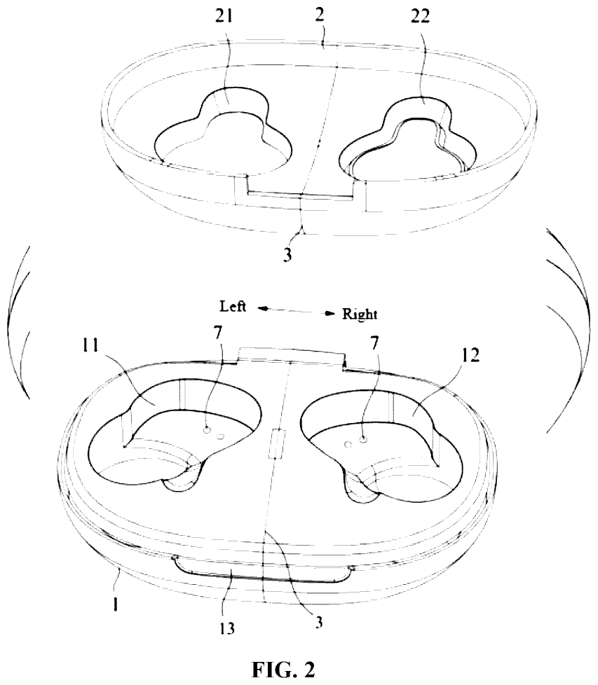

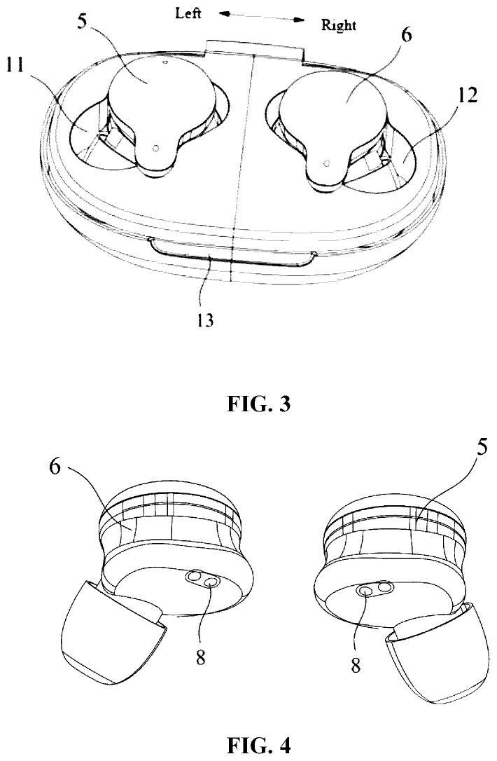

As shown in FIGS. 1 to 4, this embodiment provides an earphone case and an earphone kit. The earphone kit includes the earphone case in this embodiment. A left earphone 5 and a right earphone 6 are accommodated in the earphone case. The earphone case includes a case body 1 and a case cover 2. The case body 1 is provided with a first accommodation recess 11 for accommodating the left earphone 5 and a second accommodation recess 12 for accommodating the right earphone 6. The case cover 2 is used for covering the case body 1. The outer surface of at least one of the case body 1 or the case cover 2 is coated with a first coating and a second coating of different colors side by side, where the first coating faces the first accommodation recess 11, and the second coating faces the second accommodation recess 12. Specifically, as shown in FIGS. 1 and 2, in this embodiment, the left half of the outer surface of the case body 1 and the left half of the outer surface of the case cover 2 are coated with the first coating. The right half of the outer surface of the case body 1 and the right half of the outer surface of the case cover 2 are coated with the second coating. A coating boundary 3 is formed at the boundary between the first coating and the second coating. The first coating and the second coating may be in a bi-color collocation of red and black (red for the first coating and black for the second coating), black and white, or red and white. The arrow direction in the drawings indicates the left-right direction.

Compared with an existing earphone case, the earphone case of the present disclosure is provided with the first coating and the second coating, thus having a more aesthetic appearance. Moreover, the first coating faces the first accommodation recess 11, and the second coating faces the second accommodation recess 12, so that it is convenient for consumers to distinguish between the first accommodation recess 11 and the second accommodation recess 12 quickly. In this case, consumers can easily place the left earphone 5 and the right earphone 6 into the first accommodation recess 11 and the second accommodation recess 12 respectively, and thus the user experience is improved.

Further, as shown in FIGS. 2 to 4, of the earphone kit provided in this embodiment, the outer surface of the left earphone 5 is coated with the first coating and the outer surface of the right earphone 6 is coated with the second coating. Accordingly, consumers, after taking out the left earphone 5 and the right earphone 6, can distinguish between left earphone 5 and the right earphone 6 quickly and directly based on the color difference between the first coating and the second coating. This arrangement guarantees an aesthetic appearance and facilitates consumers in wearing or placing the left earphone 5 and the right earphone 6 into the first accommodation recess 11 and the second accommodation recess 12 respectively.

Additionally, the case body 1 is provided with a first mark and a second mark (not shown) for distinguishing between the first accommodation recess 11 and the second accommodation recess 12. The first mark may be “L”. The second mark may be “R”. The first mark is disposed on a side of the first accommodation recess 11. The second mark is disposed on a side of the second accommodation recess 12. In other embodiments, for the purpose of bettering the impression of the earphone case, the first mark and the second mark may not be disposed. The arrangement of the first mark and the second mark helps consumers distinguish between the first accommodation recess 11 for accommodating the left earphone 5 and the second accommodation recess 12 for accommodating the right earphone 6.

Further, as shown in FIG. 1, in this embodiment, the shell of the case cover 2 and the shell of the case body 1 are each semi-oval. When the case cover 2 covers the case body 1, the case cover 2 and the case body 1 form an oval structure. The oval structure, with a smooth curved surface and no sharp edges, further enables a comfortable holding for consumers.

Further, as shown in FIGS. 1 and 2, the case cover 2 is pivotably connected to the case body 1 by using a pivot shaft (not shown). The clamshell-type design structure has the advantage of low cost. The case cover 2, since connected to the case body 1, is not easily lost.

Further, as shown in FIGS. 1 to 3, in this embodiment, an opening and closing notch 13 is disposed in the outer wall of the case body 1. The opening and closing notch 13 penetrates through a side wall of the case body 1 facing the case cover 2. The opening and closing notch 13 exposes the edge of the case cover 2 facing the case body 1, helping consumers perform an opening and closing operation on the case cover 2.

Further, a locking magnetic block (not shown) is disposed at the opening and closing notch 13 of the case body 1. A metal piece (not shown) attractable by the locking magnetic block is disposed on the case cover 2. Accordingly, when the case cover covers the case body, the locking magnetic block attracts the metal piece to make the covering of the case cover 2 more stable.

Further, as shown in FIG. 2, a first stop recess 21 and a second stop recess 22 are disposed in the inner wall of the case cover 2. When the case cover 2 covers the case body 1, the inner wall of the first stop recess 21 is abuttable against and stopped by the outer wall of the left earphone 5, and the inner wall of the second stop recess 22 is abuttable against and stopped by the outer wall of the right earphone 6. Accordingly, when the case cover 2 covers the case body 1, the inner walls of the first stop recess 21 and the second stop recess 22 are abuttable against and stopped by the left earphone 5 and the right earphone 6 respectively. In this case, the left earphone 5 and the right earphone 6 are stably placed in the earphone case.

Further, as shown in FIGS. 2 to 4, both the first accommodation recess 11 and the second accommodation recess 12 are provided with a first magnetic piece 7. Both the left earphone and the right earphone are provided with a second magnetic piece 8. The second magnetic piece 8 on the left earphone 5 is attractable to the first magnetic piece 7 in the first accommodation recess 11. The second magnetic piece 8 on the right earphone 6 is attractable to the first magnetic piece 7 in the second accommodation recess 12. A first magnetic piece 7 and a second magnetic piece 8 may be magnets that are magnetically opposite to and attractive to each other. Alternatively, one of a first magnetic piece 7 and a second magnetic piece 8 may be a magnet, and the other may be a metal block to be attracted. Accordingly, the left earphone 5 and the right earphone 6 can be stably placed into the corresponding first accommodation recess 11 and the second accommodating grove 12 separately. The arrangement is simply structured, of low cost, and not easily damaged.

The above are merely preferred embodiments of the present disclosure. Those of ordinary skill in the art will make modifications in embodiments and the application scope according to the present disclosure. The content of this specification is not to be construed as limiting the present disclosure.

What is claimed is:

1. An earphone case, comprising:
a case body provided with a first accommodation recess for accommodating a left earphone and a second accommodation recess for accommodating a second earphone; and
a case cover for covering the case body,
wherein an outer surface of at least one of the case body or the case cover is coated with a first coating and a second coating of different colors side by side, wherein the first coating faces the first accommodation recess, and the second coating faces the second accommodation recess.

2. The earphone case of claim 1, wherein a left half of the outer surface of the case body and a left half of the outer surface of the case cover are coated with the first coating, and a right half of the outer surface of the case body and a right half of the outer surface of the case cover are coated with the second coating.

3. The earphone case of claim 1, wherein a shell of the case cover and a shell of the case body are each semi-oval, and when the case cover covers the case body, the case cover and the case body form an oval structure.

4. The earphone case of claim 1, wherein the case cover is pivotably connected to the case body by using a pivot shaft.

5. The earphone case of claim 4, wherein an opening and closing notch is disposed in an outer wall of the case body, and the opening and closing notch penetrates through a side wall of the case body facing the case cover.

6. The earphone case of claim 5, wherein a locking magnetic block is disposed at the opening and closing notch of the case body, and a metal piece attractable by the locking magnetic block is disposed on the case cover.

7. The earphone case of claim 1, wherein the case body is further provided with a first mark and a second mark to distinguish between the first accommodation recess and the second accommodation recess, the first mark is disposed on a side of the first accommodation recess, and the second mark is disposed on a side of the second accommodation recess.

8. The earphone case of claim 1, wherein a first stop recess and a second stop recess are disposed in an inner wall of the case cover, and when the case cover covers the case body, an inner wall of the first stop recess is abuttable against and stopped by an outer wall of the left earphone and an inner wall of the second stop recess is abuttable against and stopped by an outer wall of the right earphone.

9. An earphone kit, comprising the earphone case of claim 1 and further comprising:
the left earphone, wherein an outer surface of the left earphone is coated with the first coating; and
the right earphone, wherein an outer surface of the right earphone is coated with the second coating.

10. The earphone kit of claim 9, wherein a first magnetic piece is disposed in the first accommodation recess and the second accommodation recess separately, a second magnetic piece is disposed on the left earphone and the right earphone separately, the second magnetic piece on the left earphone is attractable to the first magnetic piece in the first accommodation recess, and the second magnetic piece on the right earphone is attractable to the first magnetic piece in the second accommodation recess.

11. The earphone kit of claim 9, wherein a left half of the outer surface of the case body and a left half of the outer surface of the case cover are coated with the first coating, and a right half of the outer surface of the case body and a right half of the outer surface of the case cover are coated with the second coating.

12. The earphone kit of claim 9, wherein a shell of the case cover and a shell of the case body are each semi-oval, and when the case cover covers the case body, the case cover and the case body form an oval structure.

13. The earphone kit of claim 9, wherein the case cover is pivotably connected to the case body by using a pivot shaft.

14. The earphone kit of claim 13, wherein an opening and closing notch is disposed in an outer wall of the case body, and the opening and closing notch penetrates through a side wall of the case body facing the case cover.

15. The earphone kit of claim 14, wherein a locking magnetic block is disposed at the opening and closing notch of the case body, and a metal piece attractable by the locking magnetic block is disposed on the case cover.

16. The earphone kit of claim 9, wherein the case body is further provided with a first mark and a second mark to distinguish between the first accommodation recess and the second accommodation recess, the first mark is disposed on a side of the first accommodation recess, and the second mark is disposed on a side of the second accommodation recess.

17. The earphone kit of claim 9, wherein a first stop recess and a second stop recess are disposed in an inner wall of the case cover, and when the case cover covers the case body, an inner wall of the first stop recess is abuttable against and stopped by an outer wall of the left earphone and an inner wall of the second stop recess is abuttable against and stopped by an outer wall of the right earphone.
